(19) United States
(12) Patent Application Publication
(10) Pub. No.: US 2019/0312840 A1
(43) Pub. Date: Oct. 10, 2019

(54) AUTOMATIC TUNNELER IN A COMMUNICATION NETWORK OF AN INDUSTRIAL PROCESS FACILITY

(71) Applicant: HONEYWELL INTERNATIONAL INC., Morris Plains, NJ (US)

(72) Inventors: Chandirasekaran Dhakshinamoorthy, Banglore (IN); Mohit Agarwal, Bangalore (IN); Manibhushan Reddy Pottem, Bangalore (IN); Satheesh Bhuvaneswaran, Chennai (IN); Rod Stein, Edmonton (CA)

(21) Appl. No.: 15/948,051

(22) Filed: Apr. 9, 2018

(51) Int. Cl. H04L 29/06; H04L 12/911; H04L 12/851; H04L 29/08; G06F 15/18

(52) U.S. Cl. CPC H04L 63/029; H04L 47/825; H04L 63/0428; H04L 67/12; G06F 15/18; H04L 47/2441

(57) ABSTRACT

A method of controlling tunneling in a communication network of an industrial process facility including a client computer and server computer running different communication protocols coupled by the communication network. The method includes providing the client and server computer with a processor connected to a memory. The processor implements a tunneling reliability program including a training model including labeled groups representing reliability data and security data determined from data sources received across the communication network and a learning classifying algorithm for classifying the reliability data and security data as being reliable or not reliable. The processor determines if the communication network is reliable based on the classified reliability data and security data. In response to determining that the communication network is not reliable or secure a notification is generated for a user that the communication network is not reliable and the notification is transmitted to the user.

### FIELD

This Disclosure relates to computers used with industrial hardware devices in an industrial process facility, and more specifically relates to determining reliability of tunneling in a communication network of an industrial process facility computer system.

### BACKGROUND

Process facilities are used in various industries such as petroleum or chemical refining, pharmaceutical, ore refining pulp and paper, or other manufacturing operations. Processing facilities are often managed using process control systems. Processing facilities can include manufacturing plants, chemical plants, crude oil refineries, ore processing plants, and paper or pulp manufacturing plants. These industries typically use continuous processes and fluid processing. Process control systems typically manage the use of motors, valves, sensors, gauges and other industrial equipment in the processing facilities.

Process facilities include control systems that use communication networks to send and receive process data and instructions between various computers and devices within an industrial process facility. In an industrial process facility, many types of computers and devices are often needed to interface with other computers and devices. Unfortunately, the computers and devices are often not equipped with the correct protocols to communicate properly with other computers and devices that operate with different protocols. A tunneller is a mechanism including a tunneling protocol used to send a foreign communication protocol across a network that normally wouldn't support it that allows a network to access or provide a network service that the underlying network does not support or provide directly.

### SUMMARY

This summary is provided to introduce a brief selection of disclosed concepts in a simplified form that are further described below in the Detailed Description including the drawings provided. This Summary is not intended to limit the claimed subject matter's scope.

Disclosed embodiments recognize there is a problem for process control in conventional process facilities because known manually monitoring of thousands of communication links each running a tunneling protocol for trying to provide network reliability and security is not feasible solution. Manual monitoring of communication links running a tunneling protocol results in maintenance being performed retroactively. The increased plant downtime and increased work requests result in increased costs and increased wait times. There is thus a current unmet need for an automated predictive solution for determining the reliability and security of tunneling in communication networks of an industrial process facility computer system.

Disclosed embodiments solve this problem by including a method of controlling tunneling in a communication network of an industrial process facility including a client computer and a server computer running different communication protocols coupled by the communication network. The method includes providing the client computer and the server computer with a processor and a digital logic connected to a memory device. At least one of the processor and the digital logic are configured to implement a tunneling reliability program including a training model including a plurality of labeled groups representing reliability data and security data determined from various data sources received across the communication network and a learning classifying algorithm for classifying the reliability data and security data as being reliable or not reliable. At least one of the processor and digital logic execute determining if the communication network is reliable based on the classified reliability data and security data. In response to determining that the communication network is not reliable or secure, a notification is generated for a user that the communication network is not reliable or secure and the notification is transmitted to the user that the communication network is not reliable or secure.

### BRIEF DESCRIPTION OF THE DRAWINGS

FIG. 1 is a block diagram of an example client-server system, according to an example embodiment.

FIG. 2 is a block diagram of an example industrial process facility computer system, according to an example embodiment.

FIG. 3 is a block diagram of an example computer device, according to an example embodiment.

FIG. 4 is a block diagram of example contents of a client computer storage device, according to an example embodiment.

FIG. 5 is a flow chart that shows steps in an example method of generating a training model for reliability and security of tunneling in a communication network of an industrial process facility computer system, according to an example embodiment.

FIG. 6 is a flow chart that shows steps in an example method of determining reliability of tunneling in a communication network of an industrial process facility computer system, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

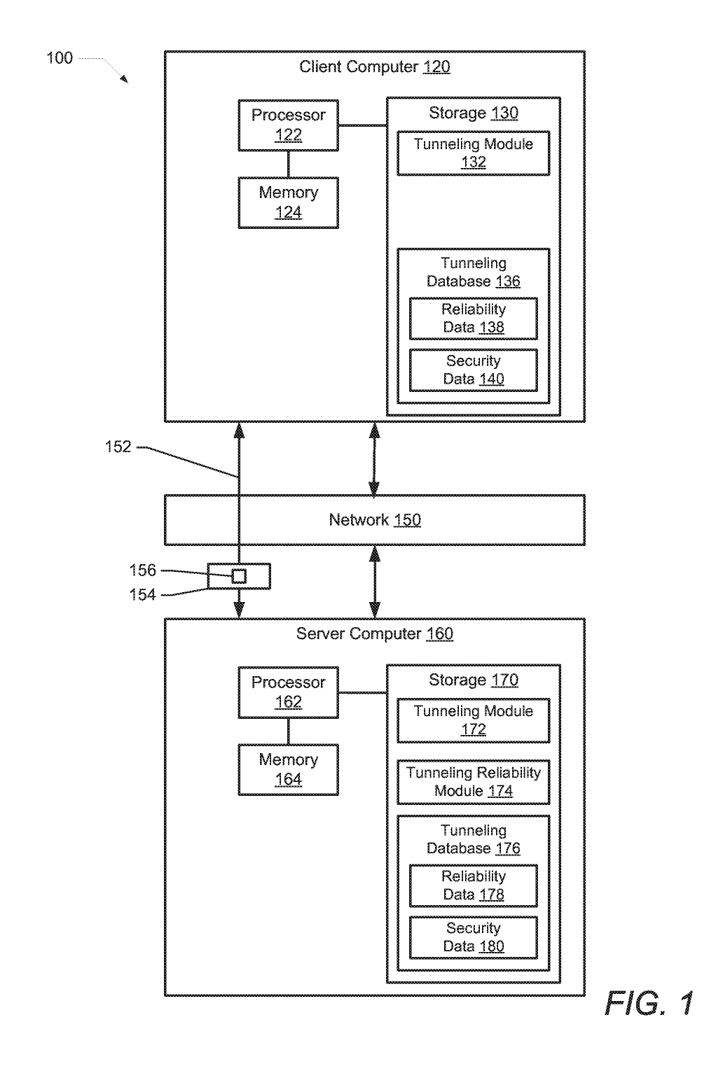

FIG. 1 illustrates a block diagram of an example client-server system 100 for determining reliability of tunneling in a communication network 150 of an industrial process facility (IPF) between computer systems. As shown in FIG. 1, client-server system 100 comprises a client computer 120 that is in communication with a server computer 160 via a communication network 150. Network 150 can represent any suitable communications network or combination of networks such as a local area network, a wide area network or a wireless network. In one embodiment, network 150 can be the Internet.

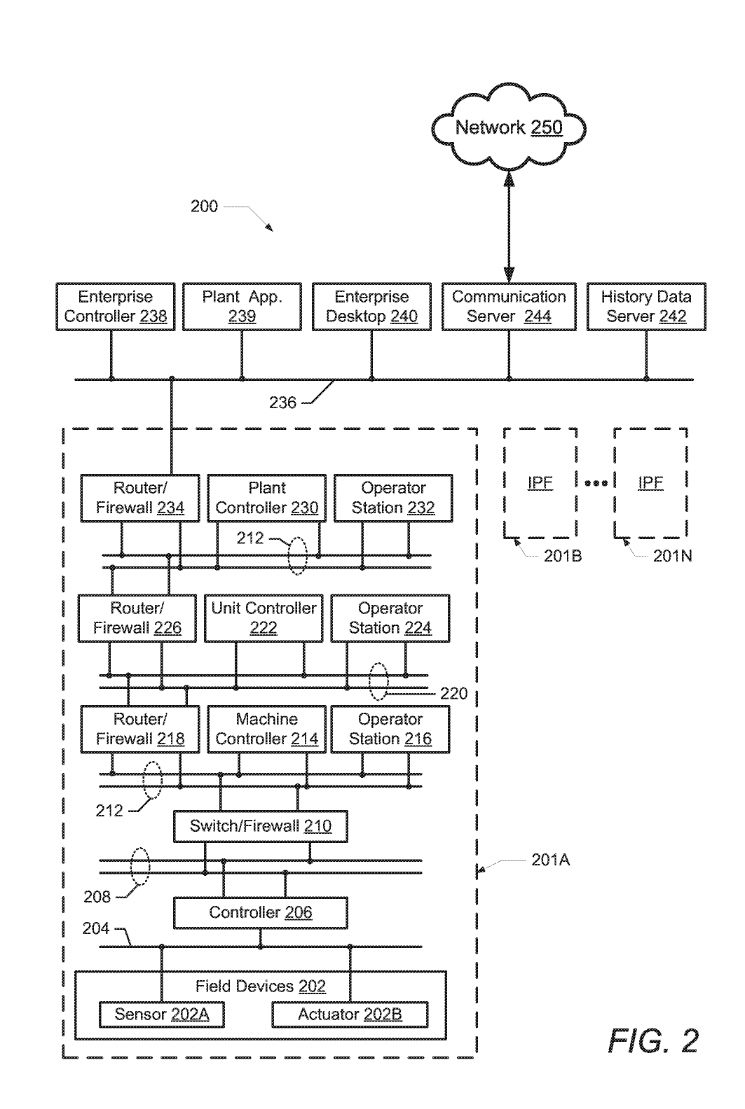

Each of client computer 120 and server computer 160 are in an IPF. See IPFs 201A, 201B-201N shown in FIG. 2 described below. The IPF can be one or more of manufacturing plants, chemical plants, crude oil refineries, ore processing plants, and paper or pulp manufacturing plants. The IPFs can be a variety of manufacturing plants or storage locations that handle, process, store and transport a powder, liquid or fluid material. These industries and facilities typically use continuous processes and fluid processing.

Client computer 120 includes a processor 122 (e.g., digital signal processor (DSP), microprocessor or microcontroller unit (MCU)) having an associated memory device or memory 124 and storage device or storage 130. Processor 122 can perform any one or more of the operations, applications, methods or methodologies described herein.

Storage 130 is shown including a client tunneling module 132. Processor 122 implements the client tunneling module 132 which provides tunneling protocols that allow communications to occur with the server computer 160 when the underlying network 150 does not support the communication protocols of the client computer 120. One important use of a tunneling protocol is to allow a foreign protocol to run over the network 150 that does not support that particular protocol. In one embodiment, client tunneling module 132 can be an open platform communication unified architecture (OPC UA) tunneling module that enables connectivity and communications between systems running OPC classic and systems running OPC UA communication protocols. For example, if client computer 120 is using OPC classic communication protocols and server computer 160 is using OPC UA communication protocols, client tunneling module 132 can facilitate communications between these non-compatible communication protocols.

Storage 130 further includes a tunneling database 136 that stores reliability data 138 and security data 140. Reliability data 138 and security data 140 are stored during the execution of client tunneling module 132. Reliability data 138 and security data 140 contain various parameters and values collected during the operation of client side tunneling module 132. Reliability data 138 and security data 140 that generally includes classic OPC logs, OPC analyzer data, OPC event data, OPC process data, OPC distributed component object model (DCOM) configurations data and OPC event viewer data.

Server computer 160 includes a processor 162 (e.g., digital signal processor (DSP), microprocessor or microcontroller unit (MCU)) having an associated memory device or memory 164 and storage device or storage 170. Processor 162 can perform any one or more of the operations, applications, methods or methodologies described herein. Processor 162 running a tunneling reliability module or digital logic is needed to perform the data processing needed to implement disclosed determining reliability of tunneling in a communication network of an IPF computer system because a human cannot monitor, record and control access to the transmission of data between clients and servers that is being continuously updated on the order of milliseconds as this is clearly too fast for a person to do.

Storage 170 is shown storing a server tunneling module 172 and a tunneling reliability module 174. Processor 162 implements the server tunneling module 172 which provides tunneling protocols that allow communications to occur with client computer 120 when the underlying network does not support the communication protocols of server computer 160. One important use of a tunneling protocol is to allow a foreign protocol to run over a network that does not support that particular protocol. In one embodiment, server tunneling module 162 can be an open platform communication unified architecture (OPC UA) tunneling module that enables connectivity and communications between systems running OPC classic and systems running OPC UA communication protocols. For example, if server computer 160 is using OPC classic communication protocols and client computer 120 is using OPC UA communication protocols, server tunneling module 172 can facilitate communications between the non-compatible communication protocols.

Processor 162 further implements the tunneling reliability module 174 which determines the reliability and security of communications between server computer 160 and client computer 120 that are enabled by the use of server tunneling module 172 and/or client tunneling module 132.

Although generally described herein as being software implemented, as known in the art, computer implemented processes such as disclosed tunneling reliability module 174 may also be implemented by hardware including digital logic. Regarding hardware-based implementations, for example, equations can be converted into a digital logic gate pattern, such as using VHDL (a Hardware Description Language) that can then be realized using a programmable device such as a field-programmable gate array (FPGA) or a dedicated application-specific integrated circuit (ASIC) to implement the logic gate pattern.

Storage 170 further includes a tunneling database 176 that stores reliability data 178 and security data 180. Reliability data 178 and security data 180 are stored during the execution of server tunneling module 172. Reliability data 178 and security data 180 contain various parameters and values collected during the operation of server tunneling module 172. Reliability data 178 and security data 180 include classic OPC Logs, OPC analyzer data, OPC event data, OPC process data, OPC distributed component object model (DCOM) configurations data and OPC event viewer data.

As described above, a tunneler is a mechanism used to transmit a foreign protocol across a network that normally does not support the other (foreign) protocol. Tunneling protocols allow for another protocol to be sent in the “data” portion of a packet. A tunneling protocol allows a network user to access or provide a network service that the underlying network does not support or provide directly. One use of a tunneling protocol is to allow a foreign protocol to run over a network that does not support that particular protocol. Another use a tunneling protocol is to provide services that are impractical to be offered using only the underlying network services. In one embodiment, tunneling can include repackaging the network traffic data into a different form, perhaps with encryption as standard. For example the data can be encrypted using different algorithms such as Advanced Encryption Standard (AES) 128, AES 256, Rivest-Shamir-Adleman (Rsa) algorithm 128 and Secure Hash Algorithm (SHA) 256. A tunneling protocol can use a data portion 156 of a packet 154 (e.g., all portions except the header) to carry the packet portion that actually provide the communication service (data content) across a communication link 152 via network 150.

Processor 162 implements the tunneling reliability module 174 which determines the reliability and security of communications between server computer 160 and client computer 120 that are enabled by the use of tunneling modules 132 and 172. In one embodiment, processor 162 retrieves reliability data 138, 178 and security data 140, 180 from tunneling databases 136 and 176 associated with network 150 in an IPF computer system. Processor 162 retrieves a training model including several labeled classes. Processor 162 classifies the reliability data and security data into the labeled classes at least partially using the training model. Processor 162 determines if the network 150 is reliable or secure based on a number of entries for each of the labeled classes. Responsive to determining that network 150 is not reliable or secure, processor 162 generates a notification to a user that the network is not reliable or secure and transmits the notification to the user.

The use of tunneling reliability module 174 enables continuous monitoring and analyzing of thousands of OPC communication links in an IPF computer system. The use of tunneling reliability module 174 provides a reliable and secure tunneling ecosystem and ensures maximum plant uptime by detecting OPC links related reliability issues using predictive machine learning algorithms. Tunneling reliability module 174 can reduce turn-around time and cost needed for user intervention to correct errors. Predicting the reliability of a tunneling ecosystem can increase customer confidence and security of an IPF computer system.

Tunneling reliability module 174 provides notifications to a user or system administrator that network 150 is not reliable or secure. After the user or system administrator has been notified that network 150 is not reliable or secure, the user or system administrator can take preventative actions prior to any failures within an IPF. The preventative actions can include planning for preventive maintenance, fine tuning process parameters and passing tentative issue information to support personnel.

FIG. 2 illustrates an example IPF computer system 200. Customer computer system 200 can monitor, collect, store and transmit process data (such as real-time data from field devices such as sensors coupled to sense parameters (e.g., temperature or pressure) associated with processing equipment) from one or more plants or IPFs 201A, 201B-201N. Each of IPF 201A-201N can be one or more of manufacturing plants, chemical plants, crude oil refineries, ore processing plants, and paper or pulp manufacturing plants. The IPFs can be a variety of manufacturing plants or storage locations that handle, process, store and transport a powder, liquid or fluid material. These industries and facilities typically use continuous processes and fluid processing. In general, each IPF can implement one or more processes and can individually or collectively be referred to as a process system. A process system generally represents any system or portion thereof configured to process one or more products or other materials in some manner.

In FIG. 2, IPF computer system 200 has one or more field devices 202 including sensors 202A and actuators 202B. The sensors 202A and actuators 202B in a process system can perform a wide variety of functions. For example, sensors 202A can measure a wide variety of characteristics in the process system, such as temperature, pressure, or flow rate. Actuators 202B coupled to processing equipment (not shown) can alter a wide variety of characteristics in the process system. The sensors 202A and actuators 202B can represent any other or additional components in any suitable process system. Each of the sensors 202A includes any suitable structure for measuring one or more characteristics in a process system. Each of the actuators 202B includes any suitable structure for operating on or affecting one or more conditions in a process system.

At least one network 204 is coupled to the sensors 202A and actuators 202B. Network 204 facilitates the controller's 206 interaction with the sensors 202A and actuators 202B. The network 204 can transport measurement data from sensors 202A and provide control signals from the controller 206 to the actuators 202B. Network 204 can represent any suitable network or combination of networks. As particular examples, the network 204 could represent an Ethernet network, an electrical signal network (such as a hart or a foundation fieldbus network), a pneumatic control signal network, or any other or additional type(s) of network(s).

One or more controllers 206 are coupled to the network 204. Each controller 206 can use measurements from one or more sensors 202A to control the operation of one or more actuators 202B. For example, controller 206 can receive measurement data from sensors 202A and use the measurement data to generate control signals for actuators 202B. Each controller 206 includes any suitable structure for interacting with sensors 202A and controlling actuators 202B. Each controller 206 could, for example, represent a proportional-integral-derivative (PID) controller or a multivariable controller, such as a robust multivariable predictive control technology (RMPCT) controller or other type of controller implementing model predictive control (MPC) or other advanced predictive control (APC). As a particular example, each controller 206 could represent a computing device running a real-time operating system.

Two networks 208 are shown coupled to controllers 206. Networks 208 facilitate interaction with controllers 206, such as by transporting data to and from the controllers 206. Networks 208 could represent any suitable networks or combination of networks. As a particular example, the networks 208 could represent a redundant pair of Ethernet networks, such as a Fault Tolerant Ethernet (FTE) network from Honeywell Corporation. At least one switch/firewall 210 couples the networks 208 to two networks 212. The switch/firewall 210 may transport traffic from one network to another. The switch/firewall 210 may also block traffic on one network from reaching another network. The switch/firewall 210 includes any suitable structure for providing communication between networks, such as a Honeywell control firewall (CF9) device. Networks 212 can represent any suitable networks, such as an FTE network.

One or more machine-level controllers 214 are coupled to networks 212. The machine-level controllers 214 perform various functions to support the operation and control of controllers 206, field devices 202, sensors 202A, and actuators 202B, which can be associated with a particular piece of industrial equipment (such as a distillation column, a boiler or other machine). For example, the machine-level controllers 214 could log information collected or generated by controllers 206, such as measurement data from sensors 202A or control signals for actuators 202B. Machine-level controllers 214 can also execute applications that control the operation of controllers 206, thereby controlling the operation of actuators 202B. Machine-level controllers 214 can also provide secure access to controllers 206. Each of the machine-level controllers 214 includes any suitable structure for providing access to, control of, or operations related to a machine or other individual piece of equipment. Each of the machine-level controllers 214 could, for example, represent a server computing device running a Windows operating system. Although not shown, different machine-level controllers 214 can be used to control different pieces of equipment in a process system (where each piece of equipment is associated with one or more controllers 206, sensors 202A and actuators 202B).

One or more operator stations 216 are coupled to networks 212. Operator stations 216 represent computing or communication devices providing user access to machine-level controllers 214, which could then provide user access to the controllers 206 (and possibly the sensors 202A and actuators 202B). As particular examples, operator stations 216 can allow users to review the operational history of sensors 202A and actuators 202B using information collected by controllers 206 and/or machine-level controllers 214. The operator stations 216 can also allow users to adjust the operation of the sensors 202A, actuators 202B, controllers 206, or machine-level controllers 214. In addition, the operator stations 216 can receive and display warnings, alerts, or other messages or displays generated by controllers 206 or machine-level controllers 214. Each of the operator stations 216 includes any suitable structure for supporting user access and control of one or more components in the customer computer system 200. Each of the operator stations 216 could, for example, represent a computing device running a Windows operating system. At least one router/firewall 218 couples networks 212 to two networks 220. Router/firewall 218 includes any suitable structure for providing communication between networks, such as a secure router or combination router/firewall. Networks 220 can represent any suitable networks, such as an FTE network.

One or more unit-level controllers 222 are coupled to networks 220. Each unit-level controller 222 can be associated with a unit in a process system, which represents a collection of different machines operating together to implement at least part of a process. The unit-level controllers 222 perform various functions to support the operation and control of components in the lower levels. For example, the unit-level controllers 222 could log information collected or generated by the components in the lower levels, execute applications that control the components in the lower levels, and provide secure access to the components in the lower levels. Each of the unit-level controllers 222 includes any suitable structure for providing access to, control of, or operations related to one or more machines or other pieces of equipment in a process unit. Each of the unit-level controllers 222 could, for example, represent a server computing device running a Windows operating system. Although not shown, different unit-level controllers 222 could be used to control different units in a process system (where each unit is associated with one or more machine-level controllers 214, controllers 206, sensors 202A and actuators 202B).

Access to the unit-level controllers 222 may be provided by one or more operator stations 224. Each of the operator stations 224 includes any suitable structure for supporting user access and control of one or more components in the customer computer system 200. Each of the operator stations 224 could, for example, represent a computing device running a Windows operating system. At least one router/firewall 226 couples the networks 220 to two networks 228. The router/firewall 226 includes any suitable structure for providing communication between networks, such as a secure router or combination router/firewall. The networks 228 could represent any suitable networks, such as an FTE network.

One or more plant or IPF level controllers 230 are coupled to networks 228. Each plant level controller 230 is typically associated with one of the plants or IPFs 201A-201N, which can include one or more process units that implement the same, similar, or different processes. The plant level controllers 230 perform various functions to support the operation and control of components in the lower levels. As particular examples, the plant level controller 230 could execute one or more manufacturing execution system (MES) applications, scheduling applications, or other or additional plant or process control applications. Each of the plant level controllers 230 includes any suitable structure for providing access to, control of, or operations related to one or more process units in a process plant. Each of the plant level controllers 230 could, for example, represent a server computing device running a Windows operating system.

Access to the plant level controllers 230 can be provided by one or more operator stations 232. Each of the operator stations 232 includes any suitable structure for supporting user access and control of one or more components in the customer computing system 200. Each of the operator stations 232 could, for example, represent a computing device running a Windows operating system. At least one router/firewall 234 couples networks 228 to one or more networks 236. Router/firewall 234 includes any suitable structure for providing communication between networks, such as a secure router or combination router/firewall. The network 236 could represent any suitable network, such as an enterprise-wide Ethernet or other network or all or a portion of a larger network (such as the Internet).

One or more enterprise level controllers 238 are coupled to network 236. Each enterprise level controller 238 is typically able to perform planning operations for multiple IPFs 201A-201N and to control various aspects of IPFs 201A-201N. The enterprise level controllers 238 can also perform various functions to support the operation and control of components in IPFs 201A-201N. As particular examples, the enterprise level controller 238 could execute one or more order processing applications, enterprise resource planning (ERP) applications, advanced planning and scheduling (APS) applications, or any other or additional enterprise control applications. Each of the enterprise level controllers 238 includes any suitable structure for providing access to, control of, or operations related to the control of one or more plants or IPFs. Each of the enterprise level controllers 238 could, for example, represent a server computing device running a Windows operating system. In this document, the term “enterprise” refers to an organization having one or more plants, IPFs or other processing facilities to be managed.

Various plant applications 239 can be executed in customer computer system 200. The plant applications 239 can represent any suitable applications that are executed by server computers or other computing devices. Access to the enterprise level controllers 238 and plant applications 239 may be provided by one or more enterprise desktops (also referred to as operator stations) 240. Each of the enterprise desktops 240 includes any suitable structure for supporting user access and control of one or more components in customer computer system 200. Each of the enterprise desktops 240 could, for example, represent a computing device running a Windows operating system.

The various levels can include other components, such as one or more databases. The database(s) associated with each level could store any suitable information associated with that level or one or more other levels of the customer computer system 200. For example, a history data server 242 can be coupled to network 236. History data server 242 can represent a component that stores various information and databases about customer computer system 200. History data server 242 can store received process information and data from IPFs 201A-201N including data from field devices 202. History data server 242 can store received process information and data and information used during production scheduling and optimization. History data server 242 represents any suitable structure for storing and facilitating retrieval of information such as a storage server. Although shown as a single centralized component coupled to network 236, History data server 242 could be located elsewhere in customer computer system 200.

In particular embodiments, the various controllers and operator stations in FIG. 2 can represent computing devices. For example, each of the controllers 206, 214, 222, 230, 238 and each of the operator stations 216, 224, 232, 240 could include one or more processing devices and one or more memories for storing instructions and data used, generated, or collected by the processing device(s). Each of the controllers 206, 214, 222, 230, 238 and each of the operator stations 216, 224, 232, 240 could also include at least one network interface, such as one or more Ethernet interfaces or wireless transceivers, facilitating communication over one or more networks or communication paths.

IPF computer system 200 further includes a communication server 244. A Communication server 244 is communicatively coupled to network 250. Communication server 244 can receive data from other components of IPF computer system 200 and transmit the data to network 250. Communication server 244 can receive data from network 250 and transmit the data to other components of IPF computer system 200. For example, communication server 244 can receive information identifying different events and historical data that occur within IPF computer system 200. Communication server 244 can represent a server computing device.

In one embodiment, the client-server system 100 of FIG. 1 can represent or be substituted for each of the controller-network-controller pairs of FIG. 2. For example, enterprise controller 238 can have the same architecture/components and correspond to server computer 160, network 236 can have the same architecture/components and correspond to network 150 and plant controller 230 can have the same architecture/components and correspond to client computer 120. In another example, plant controller 230 can have the same architecture/components and correspond to server computer 160, network 212 can have the same architecture/components and correspond to network 150 and unit controller 222 can have the same architecture/components and correspond to client computer 120.

In one embodiment, if enterprise controller 238 is executing the tunneling reliability module of FIG. 1, enterprise controller 238 can receive reliability data and security data from each of machine controller 214, unit controller 222 and plant controller 230. Enterprise controller 238 executing the tunneling reliability module of FIG. 1, can use the collective reliability data and security data to determine the reliability of tunneling in communication networks of IPF computer system 200.

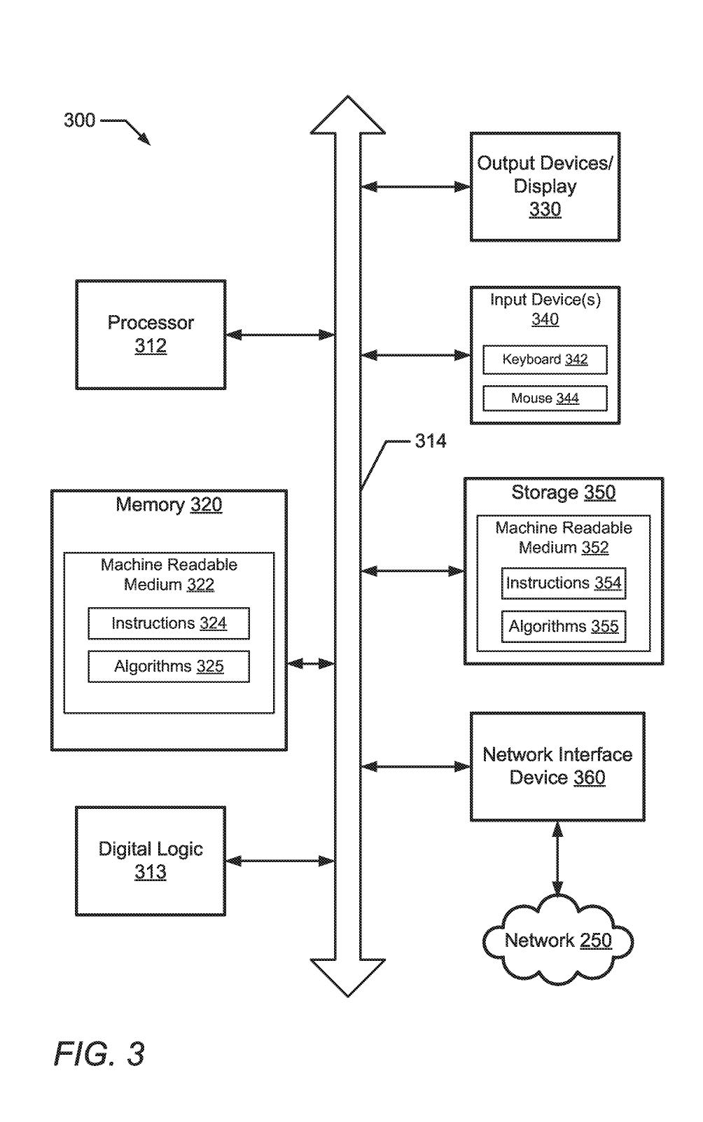

FIG. 3 illustrates an example block diagram of a computer device 300 that can be used to determine the reliability of tunneling in communication networks of IPF computer system 200. Computer device 300 can have the same components and architecture as the previously described computers, controllers, operator stations and servers of FIGS. 1 and 2. In one embodiment, computer device 300 can represent each of client computer 120 and server computer 160, shown in FIG. 1. Computer device 300 can further represent each of controllers 206, 214, 222, 230, 238, each of operator stations 216, 224, 232, 240, history data server 242, and communication server 244, shown in FIG. 2.

Computer device 300 includes one or more processors 312 such as a central processing unit (CPU) and a storage device such as memory 320, which communicate with each other via system bus 314 which can represent a data bus and an address bus. Memory 320 is a machine readable medium 322 on which is generally stored one or more sets of software such as instructions 324 and/or algorithms 325 embodying any one or more of the data access control program methodologies or functions described herein. Memory 320 can store instructions 324 and/or algorithms 325 for execution by processor 312. Computer device 300 further includes output devices/display 330 such as a video screen that is connected to system bus 314. Computer device 300 also has input devices 340 such as an alphanumeric input device (e.g., keyboard 342) and a cursor control device (e.g., a mouse 344) that are connected to system bus 314. Computer device 300 further includes digital logic 313. Digital logic 313 can be a programmable device such as a field-programmable gate array (FPGA) or a dedicated application-specific integrated circuit (ASIC) that can implement a logic gate pattern.

A storage device 350, such as a hard drive or solid state drive, is connected to and in communication with the system bus 314. The storage device 350 includes a machine readable medium 352 on which is stored one or more sets of software such as instructions 354 and/or algorithms 355 embodying any one or more of the methodologies or functions described herein. The instructions 354 and/or algorithms 355 can also reside, completely or at least partially, within the memory 320 and/or within the processor 312 during execution thereof. The memory 320 and the processor 312 can also contain machine readable media.

While the machine readable medium 322 and 352 are shown in an example embodiment to be a single medium, the term “machine readable medium” should be taken to include a single medium or multiple media (e.g., a centralized or distributed database, and/or associated caches and servers) that store the one or more sets of instructions. The term “machine readable medium” shall also be taken to include any medium that is capable of storing, encoding or carrying a set of instructions for execution by the computer system and that cause the computer system to perform any one or more of the methodologies shown in the various embodiments shown. The term “machine readable medium” shall accordingly be taken to include, but not be limited to, solid-state memories, optical and magnetic media, and carrier wave signals. Computer device 300 further includes a network interface device 360 that is connected to system bus 314. Network interface device 360 is coupled to communication network 250.

Although FIG. 3 illustrates one example of a computer device 300 that enables determining the reliability of tunneling in communication networks of an IPF computer system, various changes can be made to FIG. 3 without impacting its function. For example, components could be added, omitted, combined, further subdivided, or placed in any other suitable configuration according to particular needs. Computer devices can come in a wide variety of configurations, and FIG. 3 does not limit this disclosure to any particular configuration of computer devices.

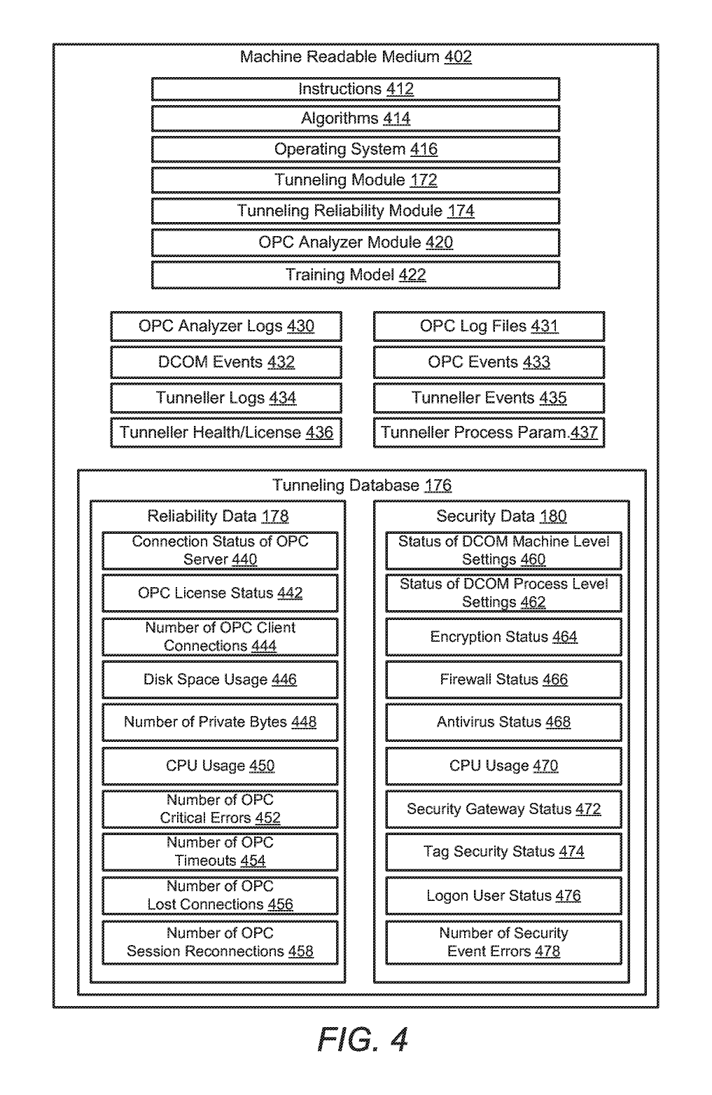

FIG. 4 illustrates example contents that are stored in storage device or storage 170 shown as a machine readable medium 402. Storage 170 includes instructions 412, algorithms 414, operating system 416 and tunneling module 172. Instructions 412 and/or algorithms 414 can enable one or more of the methodologies or functions described herein. Operating system 416 is system software that manages computer hardware and software resources of client computer 120 and provides common services for computer programs. Tunneling module 172, when executed by processor 162, provides tunneling protocols that allow communications to occur with client computer 120 when the underlying network does not support the communication protocols of server computer 160 (FIG. 1).

Storage 170 further includes tunneling reliability module 174, OPC analyzer module 420 and training model 422. Tunneling reliability module 174, when executed by processor 162, enables determining the reliability and security of communications between server computer 160 and client computer 120 that are enabled by the use of server tunneling module 172 and/or client tunneling module 132. OPC analyzer module 420, when executed by processor 162, provides for discovering common OPC problem areas and for the backup of OPC related files. Training model 422 is a model resulting from a machine learning clustering analysis of reliability data and security data. In one embodiment, the training model 422 is a k-means clustering algorithm.

Storage 170 further includes OPC analyzer logs 430, OPC log files 431, DCOM events 432, OPC events 433, tunneller logs 434, tunneller events 435, tunneller health/license state 436 and tunneller process parameters 437. Each of OPC analyzer logs 430, OPC log files 431, DCOM events 432, OPC events 433, tunneller logs 434, tunneller events 435, tunneller health/license state 436 and tunneller process parameters 437 contain various parameters and values collected from the client computer over network 150 during the operation of server tunneling module 172.

Storage 170 further includes tunneling database 176 that stores reliability data 178 and security data 180. Reliability data 178 and security data 180 contain various parameters and values collected from one or more of OPC analyzer logs 430, OPC log files 431, DCOM events 432, OPC events 433, tunneller logs 434, tunneller events 435, tunneller health/license state 436 and tunneller process parameters 437. Reliability data 178 includes connection status of OPC server 440, OPC license status 442, number of OPC client connections 444, disk space usage 446 and number of private bytes 448. Reliability data 178 further includes central processing unit (CPU) (i.e., processor 162) usage 450, number of OPC critical errors 452, number of OPC timeouts observed 454, number of OPC lost connections 456 and number of OPC session reconnections 458.

Security data 180 includes status of DCOM machine level settings 460, status of DCOM process level settings 462, encryption status 464, firewall status 466 and antivirus status 468. Security data 180 further includes CPU (i.e., processor 162) usage 470, security gateway status 462, tag security status 474, logon user status 476 and number of security event errors 478.

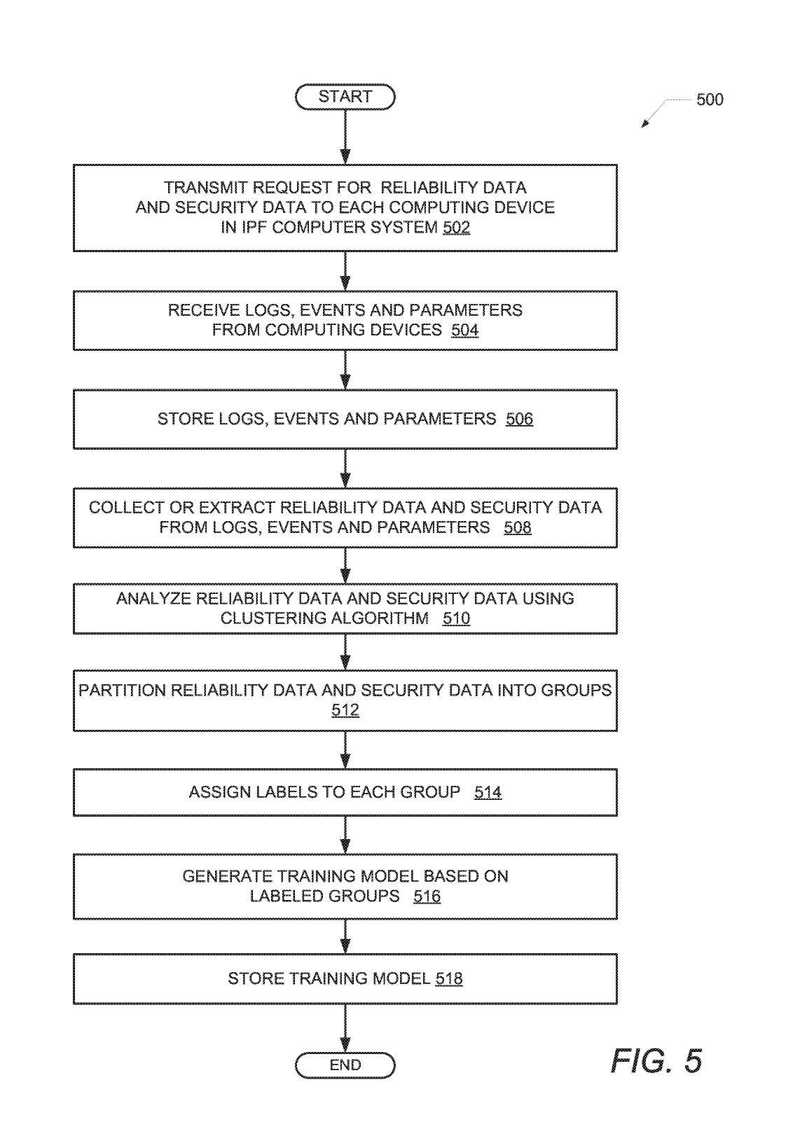

FIG. 5 is a flow chart showing steps in an example method 500 for generating a training model for reliability and security of tunneling in a communication network of IPF computer system 200. In one embodiment, method 500 can be implemented by enterprise controller 238 that has the architecture and components of server computer 160. With additional reference to FIGS. 1-4, method 500 can be implemented via the execution of instructions 412 and/or algorithms 414 by processor 162 within server computer 160 and specifically by the execution of tunneling reliability module 174 by processor 162.

Method 500 begins at the start block and proceeds to block 502. At block 502, processor 162 transmits a request for reliability and security data to each computing device (i.e., one or more of controllers 214, 222, 230 and 238) in IPF computer system 200 that is using a tunnelling module. In one embodiment, processor 162 requests each of the computing devices to transmit their respective OPC analyzer logs, OPC log files, DCOM events, OPC events, tunneller logs, tunneller events, tunneller health/license state and tunneller process parameters to server computer 160. Processor 162 receives the respective OPC analyzer logs, OPC log files, DCOM events, OPC events, tunneller logs, tunneller events, tunneller health/license state and tunneller process parameters (block 504) and stores them to storage 170 (block 506). Processor 162 collects or extracts reliability data 178 and security data 180 from OPC analyzer logs 430, OPC log files 431, DCOM events 432, OPC events 433, tunneller logs 434, tunneller events 435, tunneller health/license state 436 and tunneller process parameters 437 (block 508). These features are extracted from the client computer tunnelling module 132 in a distributed environment from OPC classic event archiver, OPC log file, DCOM Events, OPC Analyzer and other sources.

Processor 162 analyzes all of the reliability data 178 and security data 180 using a clustering algorithm (block 510). In one embodiment, the clustering algorithm can be a machine learning algorithm such as a K-means clustering algorithm. The K-means clustering algorithm partitions n observations into k clusters in which each observation belongs to the cluster with the nearest mean, serving as a prototype of the cluster. This results in a partitioning of the data space into Voronoi cells.

Processor 162 partitions the reliability data and security data into several groups based on the K-means clustering algorithm (block 512) and assigns labels 440-478 to each of the groups (block 514). Processor 162 generates training model 422 based on the labeled groups (block 516) and stores training model 422 to storage 170 (block 518). Method 500 then ends. Method 500 can be performed on a real-time basis or on a periodic basis.

In one embodiment, processor 162, executing tunneling reliability module 174 can continuously monitor IPF computer system 200 and collect reliability data and security data for each computing device where a tunneling module is installed in IPF computer system 200. Tunneling reliability module 174 can be invoked on a periodic manner or in an on-demand manner. Tunneling reliability module 174 can collect reliability data and security data that are used by a machine learning process (K-means clustering algorithm). The data sources for reliability data and security data can include classic OPC logs, OPC analyzer, OPC events, OPC process data, OPC DCOM configurations data and OPC event viewer data. Based on the reliability data and security data a training model is built.

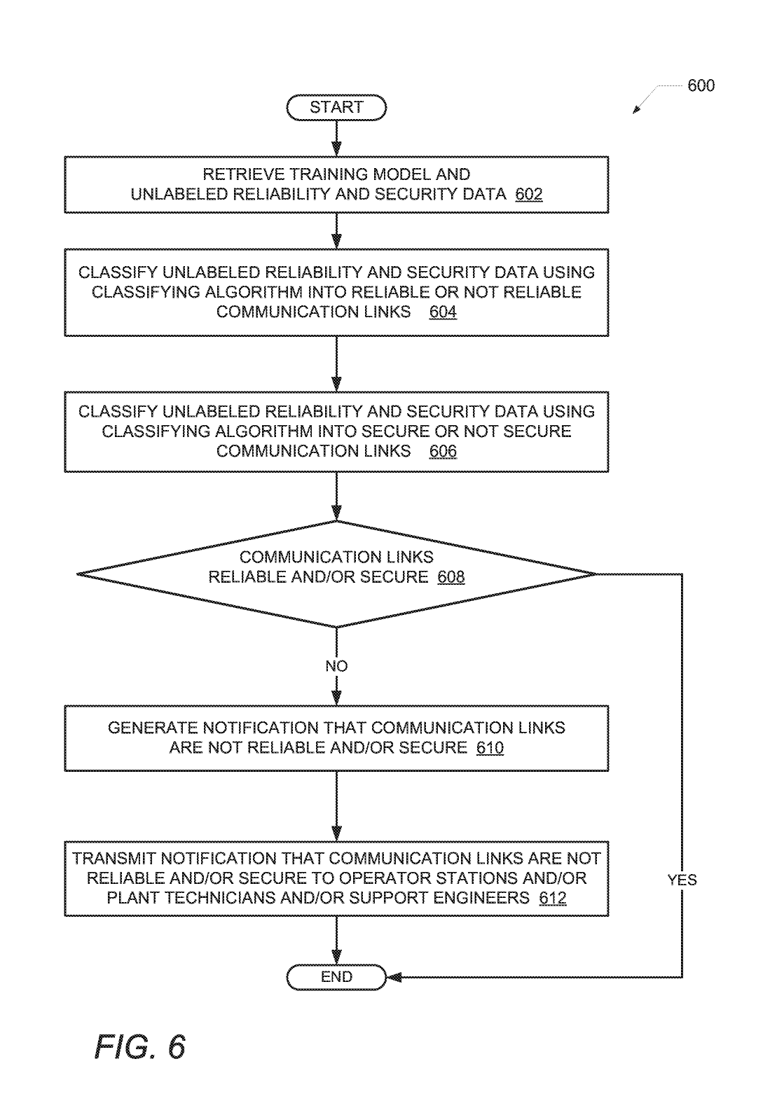

FIG. 6 is a flow chart showing steps in an example method 600 that enables determining or predicting reliability of tunneling in a communication network of an IPF computer system 200. With additional reference to FIGS. 1-4, method 600 can be implemented via the execution of instructions 412 and/or algorithms 414 by processor 162 within server computer 160 and specifically by the execution of tunneling reliability module 174 by processor 162.

Method 600 begins at the start block and proceeds to block 602. At block 602, processor 162 retrieves training model 422 that includes several labeled groups of reliability data and security data. At block 602, processor 162 also retrieves the reliability data 178 and security data 180. Processor 162 classifies the unlabeled reliability data and security data into reliable or not reliable communication links using a classifying algorithm (block 604). The reliability data and security data are classified based on the training model obtained in the clustering process. In one embodiment, the classifying algorithm can be a Naïve Bayes algorithm or a decision tree algorithm.

Naïve Bayes is a collection of classification algorithms based on Bayes theorem. It is not a single algorithm but a family of algorithms that all share a common principle, that every feature being classified is independent of the value of any other feature. So for example, a fruit may be considered to be an apple if it is red, round, and about 3″ in diameter. A Naive Bayes classifier considers each of these “features” (red, round, 3″ in diameter) to contribute independently to the probability that the fruit is an apple, regardless of any correlations between features. The features, however, aren't always independent which is often seen as a shortcoming of the Naive Bayes algorithm and this is why it's labeled “naive”. A decision tree algorithm is a decision support tool that uses a tree-like graph or model of decisions and their possible consequences, including chance event outcomes, resource costs, and utility. It is one way to display an algorithm that only contains conditional control statements.

At block 606, processor 162 classifies the unlabeled reliability data and security data into secure or not secure communication links using a classifying algorithm. Processor 162 determines if one or more of the communication links or networks in IPF computer system 200 are reliable or secure (decision block 608). In one embodiment, processor 162 can determine if the communication links or networks are reliable or secure based on the number of entries for the reliable or not reliable classes and the number of entries for the secure or not secure classes.

In response to determining that the communication links or networks are reliable and secure, method 600 ends. In response to determining that the communication links or networks are not reliable or secure, processor 162 generates a notification to a user that the communication links or networks are not reliable or secure (block 610). Processor 162 transmits the notification that the communication links or networks are not reliable or secure to one or more operator stations (i.e., operator stations 216, 224, 232 and enterprise desktop 240) (block 612) and/or to a plant technician, and/or support engineer. Method 600 then ends. Method 600 can be performed on a real-time basis or on a periodic basis.

The operator can then elect to take remedial action for reliability and security issues. In one embodiment, processor 162 can dynamically modify at least one process parameter in the IPF, identify at least one maintenance procedure in the IPF and avoid possible downtime in the IPF by predicting failures when the communication links or networks are not reliable or secure.

In one embodiment, processor 162, executing tunneling reliability module 174 can continuously monitor IPF computer system 200 and collect reliability data and security data for each computing device where a tunneling module is installed and generate a training model. The training model is fed to a supervised machine learning classifier such as a Naïve Bayes classifier or a decision tree classifier. The supervised machine learning classifier processes the periodic features collected by the tunneling reliability module and classifies the operation of the tunneling modules with the networks as being reliable and/or secure.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

1. A method for controlling tunneling in a communication network of an industrial process facility including a client computer and a server computer running different communication protocols coupled by said communication network, comprising:
providing said client computer and said server computer with a processor and a digital logic connected to a memory device, wherein at least one of said processor and said digital logic is configured to implement a tunneling reliability and security program including a training model including a plurality of labeled groups representing reliability data and security data determined from data sources received across said communication network and a learning classifying algorithm for classifying said reliability data and said security data as being reliable or not reliable, at least one of said processor and said digital logic executing:
determining if said communication network is reliable based on results of said classifying said reliability data and said security data;
responsive to determining that said communication network is not reliable or secure, generating a notification for a user that said communication network is not reliable; and
transmitting said notification to said user that said communication network is not reliable.

2. The method of claim 1, wherein at least one of said processor and said digital logic further executes:
modifying at least one process parameter in said industrial process facility;
identifying at least one maintenance procedure in said industrial process facility; and
predicting a failure in said communication network.

3. The method of claim 1, wherein at least one of said processor and said digital logic further executes:
retrieving said training model including said plurality of labeled groups representing said reliability data and said security data using a clustering process;
retrieving said reliability data and said security data;
classifying said reliability data and said security data as being reliable or not reliable using a classifying algorithm; and
classifying said reliability data and said security data as being secure or not secure using said classifying algorithm.

4. The method of claim 3, wherein said training model is based on clustering analysis of said reliability data and said security data using a clustering algorithm and said classifying said reliability data and said security data uses a machine learning clustering algorithm including a naïve bayes algorithm.

5. The method of claim 1, wherein said reliability data is chosen from the group consisting of:
connection status of open platform communication (OPC) server;
OPC license status;
number of OPC client connections;
amount of disk space usage;
number of private bytes;
central processing unit (CPU) usage;
number of OPC critical errors;
number of OPC timeouts observed;
number of OPC lost connections; and
number of OPC session reconnections.

6. The method of claim 1, wherein said security data is chosen from the group consisting of:
distributed component object model (DCOM) machine level settings;
status of DCOM process level settings;
encryption status;
firewall status;
antivirus status;
CPU usage;
security gateway status;
tag security status;
logon user status; and
number of security event errors.

7. The method of claim 1, wherein at least one of said processor and said digital logic further executes:
retrieving said reliability data and said security data from a database of reliability data and said security data associated with said communication network in said industrial process facility;
analyzing said reliability data and said security data using said clustering algorithm;
partitioning said reliability data and said security data into a plurality of groups based on said clustering algorithm;
assigning a label to each of said plurality of groups; and
generating said training model based on said plurality of labeled groups.

8. A system for controlling tunneling in a communication network of an industrial process facility, comprising:
a client computer and a server computer running different communication protocols coupled by said communication network;
each of said client computer and said server computer including a processor and a digital logic connected to a memory device, wherein at least one of said processor and said digital logic implements a tunneling reliability program including a training model including a plurality of labeled groups representing reliability data and security data determined from data sources received across said communication network and a learning classifying algorithm for classifying said reliability data and said security data as being reliable or not reliable, at least one of said processor and said digital logic executing:
determine if said communication network is reliable or secure based on said classified said reliability data and said security data; and
responsive to determining that said communication network is not reliable or secure, generate a notification to a user that said communication network is not reliable or secure; and
transmit said notification to said user that said communication network is not reliable or secure.

9. The system of claim 8, wherein said tunneling reliability program further causes at least one of said processor and said digital logic to:
modify at least one process parameter in said industrial process facility;
identify at least one maintenance procedure in said industrial process facility; and
predict a failure in said communication network.

10. The system of claim 8, wherein said tunneling reliability program further causes at least one of said processor and said digital logic to:
retrieve—said training model including a plurality of labeled groups representing said reliability data and said security data;
retrieve said reliability data and said security data;
classify said reliability data and said security data as being reliable or not reliable using a classifying algorithm; and
classify said reliability data and said security data as being secure or not secure using said classifying algorithm.

11. The system of claim 10, wherein said training model is based on clustering analysis of said reliability data and said security data using a clustering algorithm and classifying said reliability data and said security data using a machine learning classifier including a naïve bayes algorithm.

12. The system of claim 8, wherein said reliability data is chosen from the group consisting of:
connection status of open platform communication (OPC) server;
OPC license status;
number of OPC client connections;
amount of disk space usage;
number of private bytes;
central processing unit (CPU) usage;
number of OPC critical errors;
number of OPC timeouts observed;
number of OPC lost connections; and
number of OPC session reconnections.

13. The system of claim 8, wherein said security data is chosen from the group consisting of:
distributed component object model (DCOM) machine level settings;
status of DCOM process level settings;
encryption status;
firewall status;
antivirus status;
CPU usage;
security gateway status;
tag security status;
logon user status; and
number of security event errors.

14. The system of claim 8, wherein said tunneling reliability program further causes at least one of said processor and said digital logic to:
retrieve said reliability data and said security data from a database of reliability data and security data associated with said communication network in said industrial process facility;
analyze said reliability data and said security data using a clustering algorithm;
partition said reliability data and said security data into a plurality of groups based on said clustering algorithm;
assign a label to each of said plurality of groups; and
generate said training model based on said plurality of labeled groups.

15. A computer program product, comprising:
a data storage medium that includes program instructions executable by a processor to enable at least said processor to execute a method of controlling tunneling in a communication network of an industrial process facility including a client computer and a server computer running different communication protocols coupled by said communication network, said data storage medium storing a tunneling reliability program including a training model including a plurality of labeled groups representing reliability data and security data determined from data sources received across said communication network a learning classifying algorithm for classifying said reliability data and said security data as being reliable or not reliable, said computer program product comprising:
code for determining if said communication network is reliable based on classified reliability data and said security data ;
responsive to determining that said communication network is not reliable or secure, code for generating a notification for a user that said communication network is not reliable; and
code for transmitting said notification to said user that said communication network is not reliable.

16. The computer program product of claim 15, wherein said computer program product further comprises:
code for retrieving a training model including a plurality of labeled groups representing said reliability data and said security data;
code for classifying said reliability data and said security data as being reliable or not reliable using a classifying algorithm; and
code for classifying said reliability data and said security data as being secure or not secure using said classifying algorithm.

17. The computer program product of claim 16, wherein said training model is based on clustering analysis of said reliability data and said security data using a clustering algorithm and classifying said reliability data and said security data uses a machine learning classifier including a naïve bayes algorithm.

18. The computer program product of claim 15, wherein said reliability data is chosen from the group consisting of:
connection status of open platform communication (OPC) server;
OPC license status;
number of OPC client connections;
amount of disk space usage;
number of private bytes;
central processing unit (CPU) usage;
number of OPC critical errors;
number of OPC timeouts observed;
number of OPC lost connections; and
number of OPC session reconnections.

19. The computer program product of claim 15, wherein said security data is chosen from the group consisting of:
distributed component object model (DCOM) machine level settings;
status of DCOM process level settings;
encryption status;
firewall status;
antivirus status;
CPU usage;
security gateway status;
tag security status;
logon user status; and
number of security event errors.

20. The computer program product of claim 15, wherein said computer program product further comprises:
code for retrieving said reliability data and said security data from a database of reliability data and security data associated with said communication network in said industrial process facility;
code for analyzing said reliability data and said security data using a clustering algorithm;
code for partitioning said reliability data and said security data into a plurality of groups based on said clustering algorithm;
code for assigning a label to each of said plurality of groups; and
code for generating said training model based on said plurality of labeled groups.
